(19) United States
(12) Patent Application Publication
(10) Pub. No.: US 2023/0299399 A1
(43) Pub. Date: Sep. 21, 2023

(54) Pouch-Type Secondary Battery Comprising Pattern Sealing Parts, Battery Module And Device

(71) Applicant: SK On Co., Ltd., Seoul (KR)

(72) Inventors: Jeong Hyeon Yun, Daejeon (KR); Kyu Beom Kim, Daejeon (KR); Chae Rin Ryou, Daejeon (KR); Hyea Won Yun, Daejeon (KR); Ji Hyeon Lee, Daejeon (KR); Jong Chan Im, Daejeon (KR)

(21) Appl. No.: 18/122,202

(22) Filed: Mar. 16, 2023

(30) Foreign Application Priority Data
Mar. 18, 2022 (KR) 10-2022-0034310

(51) Int. Cl. H01M 50/184; H01M 50/105; H01M 50/186

(52) U.S. Cl. CPC H01M 50/184; H01M 50/105; H01M 50/186

(57) ABSTRACT

Disclosed is a pouch-type secondary battery, including an electrode assembly; a pouch configured to accommodate the electrode assembly inside; and a sealing part formed along a side circumference of the pouch. The sealing part includes a pattern sealing part in at least a portion. The pattern sealing part is provided with two or more bumpy parts protruding in a direction forming an angle of less than 90° with a height direction of the pouch. Also disclosed is a battery module including the pouch-type secondary battery as a unit cell and a device including the battery module as a power source.

### CROSS-REFERENCE TO RELATED APPLICATION

This application claims priority to Korean Patent Application No. 10-2022-0034310 filed Mar. 18, 2022, the disclosure of which is hereby incorporated by reference in its entirety.

### BACKGROUND OF THE INVENTION

### 1. Field of the Invention

The present disclosure relates to a pouch-type secondary battery including pattern sealing parts, battery module and device.

### 2. Description of Related Art

With the development of the electronics, communications, and space industries, the demand for secondary batteries as an energy power source is rapidly increasing. In particular, as the importance of global eco-friendly policies is emphasized, the electric vehicle market is growing rapidly, and research and development on secondary batteries is actively carried out at home and abroad.

In particular, in an electric vehicle battery in which multiple cells are connected in a series or parallel structure and a high nickel material is used, a technology for increasing stability by controlling the amount of gas generation in each cell and securing a gas discharge channel is required.

### SUMMARY OF THE INVENTION

Embodiments provide a pouch-type secondary battery including a pattern sealing part provided with two or more bumpy parts, which is capable of delaying the vent by distributing pressure of the gas generated inside the pouch.

In accordance with an aspect of the present disclosure, there is provided a pouch-type secondary battery, including an electrode assembly; a pouch configured to accommodate the electrode assembly inside; and a sealing part formed along a side circumference of the pouch, wherein the sealing part includes a pattern sealing part in at least a portion thereof, and the pattern sealing part is provided with two or more bumpy parts protruding in a direction forming an angle of less than 90° with a height direction of the pouch.

In accordance with another aspect of the present disclosure, there is provided a battery module including the pouch-type secondary battery according to an embodiment of the present disclosure as a unit cell.

In accordance with another aspect of the present disclosure, there is provided a device including the battery module according to an embodiment of the present disclosure as a power source.

According to an embodiment of the present disclosure, a pouch-type secondary battery including a pattern sealing part provided with two or more bumpy parts, which is capable of delaying the vent by distributing pressure of the gas generated inside the pouch, battery module and device may be provided.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a plan view of a pouch-type secondary battery including one pattern sealing part from above.

FIG. 2 schematically illustrates a cross-section cut by X-X′ of the pattern sealing part of FIG. 1.

FIG. 3 is a side view of a pouch-type secondary battery including one pattern sealing part from the side.

FIG. 4 is a plan view illustrating a pouch-type secondary battery in which two pattern sealing parts are located in a sealing part of portions where a cathode tab and an anode tab protrude.

FIG. 5 is a plan view illustrating a pouch-type secondary battery in which two pattern sealing parts are located in a sealing part of portions where a cathode tab and an anode tab do not protrude.

FIG. 6 is a plan view illustrating a pouch-type secondary battery in which two pattern sealing parts are located in a sealing part of any one portion where an electrode tab protrudes and of any one portion where an electrode tab does not protrude.

FIG. 7 is a plan view illustrating a pouch-type secondary battery in which three pattern sealing parts are located in a sealing part.

FIG. 8 is a plan view illustrating a pouch-type secondary battery in which four pattern sealing parts are located in a sealing part.

### DESCRIPTION OF THE INVENTON

The structural or functional description of the embodiments disclosed in the present specification or application is merely illustrative for the purpose of describing embodiments according to the technical spirit of the present disclosure, and the embodiments according to the technical spirit of the present disclosure can be implemented in various forms other than the embodiments disclosed in the present specification or application, and cannot be construed as limited to the embodiments set forth in the present specification or application.

A pouch-type secondary battery according to the present disclosure may include an external member, a cathode, an anode, and a separator.

Each of the cathode and anode may include a current collector and an active material layer disposed on the current collector. For example, the cathode may include a cathode current collector and a cathode active material layer, and the anode may include an anode current collector and an anode active material layer.

The current collector may include a known conductive material in the range that does not cause a chemical reaction in the lithium secondary battery. For example, the current collector may include any one of stainless steel, Ni, Al, Ti, Cu, and alloys thereof, and may be provided in various forms such as film, sheet, foil, and the like.

The active material layer includes an active material. For example, the cathode active material layer may include a cathode active material, and the anode active material layer may include an anode active material.

The cathode active material may be a material in which Li ions can be inserted and detached. The cathode active material may be lithium metal oxide. For example, the cathode active material may be one of lithium manganese oxides, lithium nickel oxides, lithium cobalt oxides, lithium nickel manganese oxides, lithium nickel cobalt manganese oxides, lithium nickel cobalt aluminum oxides, lithium iron phosphate compounds, lithium phosphate manganese compounds, lithium phosphate cobalt compounds, and lithium phosphate vanadium compounds, but is not necessarily limited to specific examples.

The anode active material may be a material in which lithium ions can be stored and detached. For example, the anode active material may be any one of crystalline carbon, amorphous carbon, carbon composite, carbon fiber or other carbon-based material, lithium alloy, Si, and Sn. According to an embodiment, the anode active material may be natural graphite or artificial graphite, but is not limited to a particular example.

The cathode and anode may further include a binder and a conductive material, respectively.

The binder can mediate the bond between the current collector and the active material layer, thereby improving mechanical stability. According to an embodiment, the binder may be an organic binder or a water-based binder and may be used with a thickener such as carboxymethyl cellulose (CMC). According to an embodiment, the organic binder is any one of vinylidene fluoride-hexafluoropropylene copolymer (PVDF-co-HFP), polyvinylidene fluoride (PVDF), polyacrylonitrile, and polymethylmethancrylate, and the water-based binder may be, styrenebutadiene rubber (SBR), but is not necessarily limited thereto.

The conductive material may improve the electrical conductivity of lithium secondary batteries. The conductive material may include a metal-based material. According to an embodiment, the conductive material may include a conventional carbon based conductive material. For example, the conductive material may include any one of graphite, carbon black, graphene, and carbon nanotubes. Preferably, the conductive material may include carbon nanotubes.

The separator may be disposed between the cathode and anode. The separator prevents electrical short circuits between the cathode and anode and is configured to generate the flow of ions.

According to an embodiment, the separator may include a porous polymer film or a porous nonwoven fabric. Here, the porous polymer film may be composed of a single layer or multiple layers, including polyolefin-based polymers such as ethylene polymers, propylene polymers, ethylene / butene copolymers, ethylene / hexene copolymers, and ethylene / methacrylate copolymers. The porous nonwoven fabric may include glass fibers with a high melting point, polyethylene terephthalate fibers. However, it is not limited thereto, and according to an embodiment, the separator may be a ceramic coated separator (CCS) including ceramic.

According to an embodiment, an electrode cell including a cathode, an anode, and a separator may be provided. A plurality of electrode cells may be provided and may be sequentially stacked in an external member.

According to an embodiment, an electrode cell including a cathode, an anode, and a separator may be provided. A plurality of electrode cells may be provided, and winding, lamination, or folding may be performed, thereby providing an electrode assembly.

The electrode assembly may be provided with an electrolyte to produce a lithium secondary battery according to an embodiment.

The electrolyte may be a non-aqueous electrolyte. The electrolyte may include lithium salts and organic solvents.

According to an embodiment, the organic solvent may include one of propylene carbonate (PC), ethylene carbonate (EC), diethyl carbonate (DEC), dimethyl carbonate (DMC), ethyl methyl carbonate (EMC), methylpropyl carbonate (MPC), dipropyl carbonate (DPC), vinylene carbonate (VC), dimethyl sulfoxide, acetonitrile, dimethoxyethane, diethoxyethane, sulfolane, gamma-butyrolactone, propylene sulfide, and tetrahydrofuran.

The present disclosure is a pouch-type secondary battery, including an electrode assembly; a pouch configured to accommodate the electrode assembly inside; and a sealing part formed along a side circumference of the pouch wherein the sealing part includes a pattern sealing part in at least a portion, wherein the pattern sealing part is provided with two or more bumpy parts protruding in a direction forming an angle of less than 90° with a height direction of the pouch.

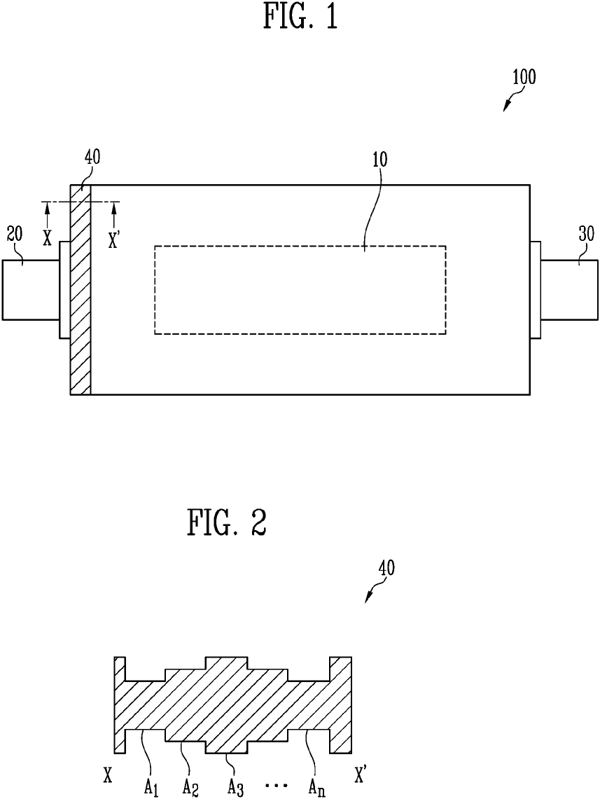

FIG. 1 is a plan view of a pouch-type secondary battery including one pattern sealing part from above. Referring to FIG. 1, a pouch-type secondary battery 100 according to an embodiment of the present disclosure includes an electrode assembly; a pouch 60 configured to accommodate the electrode assembly inside; and a sealing part 50 formed along a side circumference of the pouch.

The pouch-type secondary battery 100 of FIG. 1 is shown as an example in which a cathode tab 20 and an anode tab 30 extended in the electrode assembly exist in different sides, respectively, and are not limited thereto. For example, in the pouch-type secondary battery of the present disclosure, the cathode tab 20 and the anode tab 30 extended in the electrode assembly may exist on the same one side. The cathode tab 20 may be connected to the cathode of the electrode assembly, and the anode tab 30 may be connected to the anode of the electrode assembly. The cathode tab 20 and the anode tab 30 may each protrude from the inside of the pouch 60 through the sealing part 50 to the outside of the pouch 60.

The pouch 60 may accommodate an electrode assembly inside, and in this case, the space inside the pouch 60 in which the electrode assembly may be disposed may be defined as an accommodating part 10. In the drawings herein, the pouch is shown having a cuboid shape, but is not limited thereto, and may be formed into various shapes in which an electrode assembly may be accommodated therein.

The sealing part 50 is formed along the side circumference of the pouch 60. Here, the side circumference may mean the outer circumference of the pouch 60 in a direction perpendicular to the height direction of the pouch to be described later. FIG. 1 is plan view of a pouch-type secondary battery from above, i.e., a plan view of a pouch-type secondary battery in the height direction of the pouch, and accordingly, the sealing part 50 may be formed on the rectangular outer circumference of FIG. 1. A pattern sealing part 40 may be located in a portion of the sealing part 50.

The sealing part may include a pattern sealing part 40 in at least a portion, and the pattern sealing part 40 may be provided with two or more bumpy parts protruding in a direction that forms an angle of less than 90° to the height direction of the pouch. Here, the height direction may refer to a direction perpendicular to the plane including the direction in which the electrode tab protrudes. In other words, FIG. 1 is a plan view of a pouch-type secondary battery from above, and this plan view may be a plane including a direction in which the electrode tab protrudes, and the height direction perpendicular thereto may refer to a direction looking at the pouch-type secondary battery in FIG. 1. Preferably, the bumpy part may protrude in a direction forming an angle of 60° or less to the height direction of the pouch, more preferably in a direction forming an angle of 30° or less to the height direction of the pouch, and most preferably in the height direction of the pouch. In addition, the bumpy part may protrude in the upper direction of the pouch, i.e., in the direction coming out of the plane of FIG. 1, and may protrude in the lower direction of the pouch, i.e., in the direction entering the plane of FIG. 1, and may protrude toward both the upper and lower directions of the pouch.

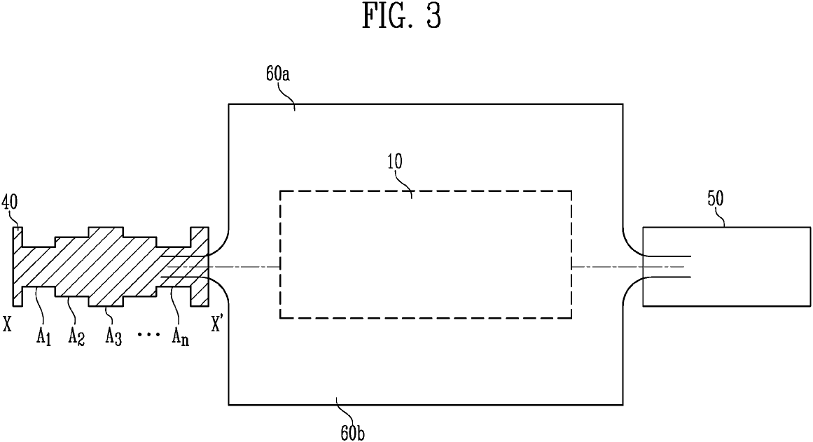

FIG. 2 schematically illustrates a cross-section cut by X-X′ of the pattern sealing part of FIG. 1, and referring to FIG. 2, the pattern sealing part includes two or more bumpy parts protruding in a height direction of the pouch, for example, as shown in FIG. 2, it may include n bumpy parts, i.e., a plurality of bumpy parts of A1 to An (where n is an integer of 2 or more) protruding in a direction parallel to the surface. The number of bumpy parts of the pattern sealing part may be two or more, three or more, four or more, or five or more, and may be 10 or less, 9 or less, 8 or 7 or less, for example, 2 to 10, 3 to 9, or 4 to 8. According to the size of the pouch-type secondary battery according to the present disclosure, the number of bumpy parts included in each pattern sealing part may be different. If the number of bumpy parts in the pattern sealing part is too small or too large, the effect of dissipating the pressure of the gas generated inside the pouch may be insignificant, or the space efficiency inside the pouch may be reduced. In FIG. 2, the bumpy parts are disclosed as protruding toward both the upper and lower directions of the pouch, but is not limited thereto, and may protrude only in the upper direction of the pouch or only in the lower direction of the pouch. In addition, in FIG. 2, the bumpy parts are illustrated to protrude in a direction parallel to the height direction of the pouch, i.e., in a direction perpendicular to X-X′, but is not limited thereto, and may protrude in various directions forming an angle of less than 90° with the height direction of the pouch.

Any one bumpy part of the pattern sealing part and another bumpy part adjacent to the bumpy part may have different heights from each other. Here, the height of the bumpy part refer to the length from one end of the bumpy part to the other end in the direction of protruding. When the adjacent bumpy part has a different height and the height of the bumpy part is increased or decreased, the cross-section of the pattern sealing part may be in the form of a step as shown in FIG. 2. In another embodiment, there may be bumpy parts of various heights in which the height of the pattern sealing part does not increase or decrease sequentially.

Due to the high-capacity battery design trend, recent batteries generate gas during the cycle life, which causes the pouch sealing part to vent, and as the gas pressure inside the battery increases, a vent occurs pushing the most vulnerable part of the pouch sealing part. Since the pattern sealing part of the pouch-type secondary battery according to the present disclosure has two or more bumpy parts protruding in the height direction of the pouch, the inside of the pattern sealing part serves as a gas passage having various paths. In other words, the gas generated inside the pouch may be discharged in a direction perpendicular to the height direction of the pouch, i.e., in a direction x′ to x in FIG. 2, and at this time, the gas generated inside the pouch may be dissipated in various paths by providing bumpy parts not parallel to the x-x′ direction, preferably perpendicular to the x-x′ direction, and accordingly, it is possible to distribute the force that causes the vent in the weak area to other areas.

The height of each bumpy part of the pattern sealing part may be 0.01 mm or more, 0.015 mm or more, 0.02 mm or more, 0.025 mm or more, or 0.03 mm or more, and may be 1 mm or less, 0.8 mm or less, 0.7 mm or less, 0.6 mm or 0.5 mm or less, for example, 0.01 to 1 mm, 0.015 to 0.8 mm, or 0.02 to 0.5 mm. According to the size of the pouch-type secondary battery according to the present disclosure, the height of each bumpy part provided in each pattern sealing part may be different. When the height of the bumpy part of the pattern sealing part is too low or too high, the effect of dissipating the pressure of the gas generated inside the pouch may be insignificant, or the space efficiency inside the pouch may be reduced.

The width of each bumpy part of the pattern sealing part may be at least 0.1 mm, at least 0.15 mm, at least 0.2 mm, at least 0.25 mm or at least or at least 0.3 mm, and may be 5 mm or less, 4.5 mm or less, 4 mm or less, 3.5 mm or less or 3 mm or less, for example, 0.1 to 5 mm, 0.15 to 4.5 mm, or 0.2 to 4 mm. According to the size of the pouch-type secondary battery according to the present disclosure, the width of each bumpy part included in each pattern sealing part may be different. When the width of the bumpy part of the pattern sealing part is too narrow or too wide, the effect of dissipating the pressure of the gas generated inside the pouch may be insignificant, or the space efficiency inside the pouch may be reduced.

The area of the pattern sealing part may be at least 10%, at least 15%, at least 20%, at least 25% or at least 30%, and may be 90% or less, 80% or less, 70% or less, 60% or less or 50% or less with respect to 100% of the total area of the sealing part, for example, 10% to 90%, 15% to 80% or 30% to 50%. When the area of the pattern sealing part is out of the above value, the effect of dissipating the pressure of the gas generated inside the pouch may be insignificant, or the space efficiency inside the pouch may be reduced.

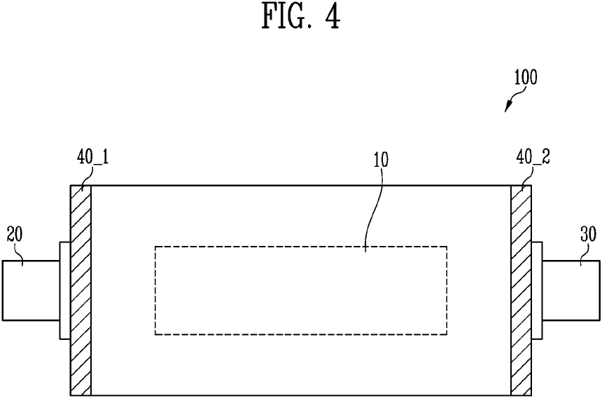

FIG. 3 is a side view of a pouch-type secondary battery including one pattern sealing part from the side. The pouch 60 may include an upper pouch 60a located at the upper part and a lower pouch 60b located at the lower part. The sealing part 50 or the pattern sealing part 40 may be formed to couple the upper pouch 60a and the lower pouch 60b. Here, the bumpy part of the pattern sealing part 40 may be formed to protrude in the upper direction of the pouch in which the upper pouch 60a is located and the lower direction in which the lower pouch 60b exists. In FIG. 3, the bumpy part is disclosed as protruding toward both the upper and lower directions of the pouch, but is not limited thereto, and may protrude only toward the upper direction of the pouch, or protrude only toward the lower direction of the pouch. In addition, in FIG. 3, the bumpy part is illustrated to protrude in the height direction of the pouch, but is not limited thereto, and may protrude in various directions forming an angle less than 90 ° to the height direction of the pouch.

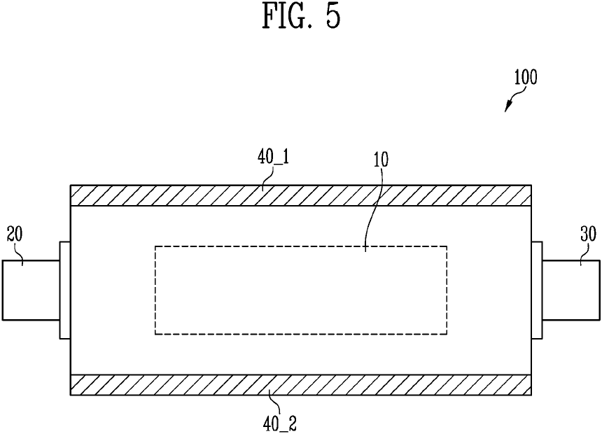

The pouch-type secondary battery according to the present disclosure may include two or more pattern sealing parts, and the two or more pattern sealing parts may be spaced apart from each other within the sealing part. For example, FIG. 4 is a plan view illustrating a pouch-type secondary battery in which two pattern sealing parts 40_1 and 40_2 are located in the sealing part of portions where the cathode tab and the anode tab protrude, and FIG. 5 is a plan view illustrating another example of a pouch-type secondary battery in which two pattern sealing parts 40_1 and 40_2 are located in the sealing part of portions where the cathode tab and the anode tab do not protrude.

Referring to FIG. 4, the two pattern sealing parts 40_1 and 40_2 may be located, among the sealing part 50, in one portion in which the cathode tab 20 protrudes and another portion in which the anode tab 30 protrudes. Referring to FIG. 5, the two pattern sealing parts 40_1 and 40_2 may be spaced apart from the portions in which the cathode tab 20 and the anode tab 30 of the sealing unit 50 do not protrude.

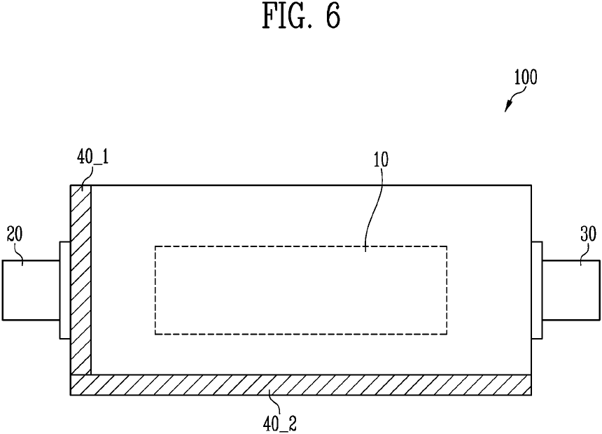

In addition, in the pouch-type secondary battery of the present disclosure, two pattern sealing parts may be located, among the sealing part, in a portion in which the electrode tab protrudes and a portion in which the electrode tab does not protrude. FIG. 6 is a plan view illustrating a pouch-type secondary battery in which two pattern sealing parts are located in a sealing part of any one portion where an electrode tab protrudes and of any one portion where an electrode tab does not protrude. Referring to FIG. 6, the two pattern sealing parts 40_1 and 40_2 may be located, among the sealing part, in a portion in which the cathode tab 20 protrudes and in a portion in which both the cathode tab 20 and the anode tab 30 do not protrude.

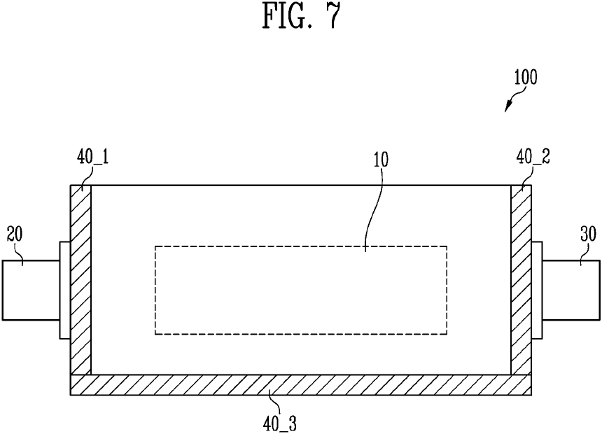

In addition, FIG. 7 is a plan view illustrating a pouch-type secondary battery in which three pattern sealing parts are located in a sealing part. Referring to FIG. 7, three pattern sealing parts 40_1, 40_2, and 40_3 are located, among the sealing part 50, in a portion in which the cathode tab 20 protrudes, a portion in which the anode tab 30 protrudes, and a portion in which both the cathode tab 20 and the anode tab 30 do not protrude. As another example of a pouch-type secondary battery in which three pattern sealing parts are located, although not shown in the figures, three pattern sealing parts may be located, among the sealing part, in two portions in which the cathode tab 20 and the anode tab 30 do not protrude, and in any one portion in which the cathode tab 20 or the anode tab 30 protrudes.

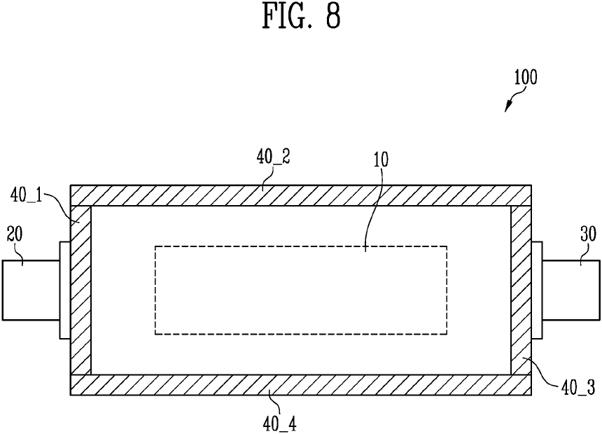

FIG. 8 is a plan view illustrating a pouch-type secondary battery in which four pattern sealing parts are located in a sealing part. Referring to FIG. 8, four pattern sealing parts 40_1, 40_2, 40_3, and 40_4 may be located, among the sealing part 50, in a portion in which the cathode tab 20 protrudes, a portion in which the anode tab 30 protrudes, and two portions in which both the cathode tab 20 and the anode tab 30 do not protrude.

In the case of FIG. 4 to FIG. 8, the cross-section of the pouch 60 may have a rectangular shape, and the sealing part 50 formed on the outer circumference of the cross section may be formed along the side of a rectangle which is the cross section of the pouch, and the pattern sealing part 40 may be located on any one side of the rectangle. However, it is not limited to the cross-sectional shape of the pouch, and the pattern sealing part may be disposed in various locations according to the cross-sectional shape of the various pouches. For example, the cross section of the pouch may have a polygonal shape including less than four or more than four sides, or may have a shape such as a circle, an oval, or the like. In addition, one pattern sealing part 40 is illustrated as being formed on the entire one side constituting the outer circumference of the cross section of the pouch, but is not limited thereto and may be formed only for a portion of one side. Furthermore, the plurality of pattern sealing parts 40 may be disposed apart from each other, but may be continuously disposed with each other and recognized as one pattern sealing part 40.

The battery module according to an embodiment of the present disclosure includes a pouch-type secondary battery according to an embodiment of the present disclosure as a unit cell. The inside of the pattern sealing part included in the pouch-type secondary battery according to an embodiment of the present disclosure serves as a gas passage having various paths. Therefore, since the gas generated inside the pouch may be dissipated in various pathways, the force causing the vent at the vulnerable site may be distributed to another site, and the battery module including the pouch-type secondary battery of the present disclosure as a unit cell may have improved stability with respect to gas pressure and the like.

The device according to an embodiment of the present disclosure includes a battery module according to an embodiment of the present disclosure as a power source.

While the present disclosure has been shown and described with reference to certain exemplary embodiments thereof, it will be understood by those skilled in the art that various changes in form and details may be made therein without departing from the spirit and scope of the present disclosure as defined by the appended claims and their equivalents. Therefore, the scope of the present disclosure should not be limited to the above-described exemplary embodiments but should be determined by not only the appended claims but also the equivalents thereof.

In the above-described embodiments, all steps may be selectively performed or part of the steps and may be omitted. In each embodiment, the steps are not necessarily performed in accordance with the described order and may be rearranged. The embodiments disclosed in this specification and drawings are only examples to facilitate an understanding of the present disclosure, and the present disclosure is not limited thereto. That is, it should be apparent to those skilled in the art that various modifications can be made on the basis of the technological scope of the present disclosure.

Meanwhile, the exemplary embodiments of the present disclosure have been described in the drawings and specification. Although specific terminologies are used here, those are only to explain the embodiments of the present disclosure. Therefore, the present disclosure is not restricted to the above-described embodiments and many variations are possible within the spirit and scope of the present disclosure. It should be apparent to those skilled in the art that various modifications can be made on the basis of the technological scope of the present disclosure in addition to the embodiments disclosed herein.

1. A pouch-type secondary battery, comprising:
an electrode assembly;
a pouch configured to accommodate the electrode assembly inside; and
a sealing part formed along a side circumference of the pouch,
wherein the sealing part comprises a pattern sealing part in at least a portion thereof, and
the pattern sealing part is provided with two or more bumpy parts protruding in a direction forming an angle of less than 90° with a height direction of the pouch.

2. The pouch-type secondary battery of claim 1, wherein any one bumpy part of the pattern sealing part and another bumpy part adjacent to the any one bumpy part have different heights.

3. The pouch-type secondary battery of claim 1, wherein a height of each bumpy part of the pattern sealing part is 0.01 mm to 1 mm.

4. The pouch-type secondary battery of claim 1, wherein the number of the bumpy parts of the pattern sealing part is 2 to 10.

5. The pouch-type secondary battery of claim 1, wherein a width of each bumpy part of the pattern sealing part is 0.1 mm to 5 mm.

6. The pouch-type secondary battery of claim 1, wherein an area of the pattern sealing part is 10% to 90% with respect to 100% of a total area of the sealing part.

7. The pouch-type secondary battery of claim 1, wherein a cathode tab connected to a cathode of the electrode assembly and an anode tab connected to an anode of the electrode assembly protrude from inside of the pouch through the sealing part to outside of the pouch, respectively, and
pattern sealing parts are respectively located in portions of the sealing part where the cathode tab and the anode tab protrude.

8. The pouch-type secondary battery of claim 1, wherein
a cathode tab connected to a cathode of the electrode assembly and an anode tab connected to an anode of the electrode assembly protrude from inside of the pouch through the sealing part to outside of the pouch, respectively, and
pattern sealing parts are respectively located in portions of the sealing part where the cathode tab and the anode tab do not protrude.

9. The pouch-type secondary battery of claim 1, wherein the bumpy part protrudes in the height direction of the pouch.

10. The pouch-type secondary battery of claim 1, wherein the pouch comprises an upper pouch located at its upper part and a lower pouch located at its lower part, and the sealing part is formed to couple the upper pouch and the lower pouch.

11. The pouch-type secondary battery of claim 10, wherein the bumpy part protrudes toward in a direction of the upper part or the lower part.

12. A battery module comprising the pouch-type secondary battery according to claim 1 as a unit cell.

13. A device comprising the battery module according to claim 12 as a power source.
